(19) United States
(12) Patent Application Publication
(10) Pub. No.: US 2021/0095588 A1
(43) Pub. Date: Apr. 1, 2021

(54) DECOMPOSITION PIPE FOR HEATED DOSER

(71) Applicant: Faurecia Emissions Control Technologies, USA, LLC, Columbus, IN (US)

(72) Inventors: Madhuri Gandikota, Columbus, IN (US); Eduardo Alano, Columbus, IN (US); Mahesh Mandiganahalli, Bangalore (IN); Santosh Channappa, Shivamogga (IN); Jeff Prairie, Franklin, IN (US)

(21) Appl. No.: 16/585,134

(22) Filed: Sep. 27, 2019

(51) Int. Cl. F01N 3/20; B01D 53/94; B01F 3/04; B01F 3/20; B01F 5/04; B01F 5/06

(52) U.S. Cl. CPC F01N 3/2066; B01D 53/9431; B01F 3/04049; F01N 2610/14; B01F 5/0473; B01F 5/0616; B01F 5/0689; B01F 3/2078

(57) ABSTRACT

A vehicle exhaust system includes a conduit defining an exhaust gas flow path extending along a center axis, and wherein the conduit includes a doser opening. An exhaust gas aftertreatment component is positioned downstream of the conduit and at least one doser is configured to inject fluid into the conduit through the doser opening. A heating element pre-heats the fluid prior to mixing with exhaust gas. A perforated pipe is positioned within the exhaust gas flow path to surround the fluid injected by the doser.

### BACKGROUND

An exhaust system includes catalyst components to reduce emissions. The exhaust system includes an injection system that injects a diesel exhaust fluid (DEF), or a reducing agent such as a solution of urea and water for example, upstream of a selective catalytic reduction (SCR) catalyst which is used to reduce NOx emissions. The injection system includes a doser that sprays the fluid into the exhaust stream. The fluid spray should be transformed as much as possible into ammonia (NH₃) before reaching the SCR catalyst. Providing for ultra-low NOx emissions requires dosing at low temperatures to address reducing emissions at cold start and low load cycles. Dosing DEF at low temperatures is a thermolysis and deposit formation problem as there is insufficient heat.

### SUMMARY

In one exemplary embodiment, vehicle exhaust system includes a conduit defining an exhaust gas flow path extending along a center axis, and wherein the conduit includes a doser opening. An exhaust gas aftertreatment component is positioned downstream of the conduit and at least one doser is configured to inject fluid into the conduit through the doser opening. A heating element pre-heats the fluid prior to mixing with exhaust gas. A perforated pipe is positioned within the exhaust gas flow path to surround the fluid injected by the doser.

In a further embodiment of the above, a mixer is positioned upstream of the exhaust gas aftertreatment component and downstream of the perforated pipe.

In a further embodiment of any of the above, the mixer comprises an outer band fixed to an inner surface of the conduit and a plurality of deflecting elements supported by the band.

In a further embodiment of any of the above, the plurality of deflecting elements comprise flat tabs having one end associated with the band and extending to an unsupported distal end at an angle relative to the center axis.

In a further embodiment of any of the above, the perforated pipe includes a plurality of openings spaced apart from each other about the axis.

In a further embodiment of any of the above, an upstream portion of the perforated pipe extends outwardly of the conduit through the doser opening and wherein a downstream portion of the perforated pipe includes the plurality of openings that are axially spaced apart from each other and extend to an outlet end of the perforated pipe.

In a further embodiment of any of the above, the mixer is positioned immediately adjacent to an outlet end of the perforated pipe.

In a further embodiment of any of the above, the doser injects along an injection axis that is parallel to the center axis.

In a further embodiment of any of the above, the doser injects along an injection axis that is non-parallel to the center axis.

In a further embodiment of any of the above, the perforated pipe is defined by an outer diameter that remains constant along a length of the perforated pipe.

In a further embodiment of any of the above, the perforated pipe is defined by an outer diameter that varies along a length of the perforated pipe.

In a further embodiment of any of the above, the at least one doser comprises a plurality of dosers.

In a further embodiment of any of the above, a control system controls heating of the fluid and/or injection of the fluid based on one or more of exhaust gas temperature, backpressure, time, and wear.

In another exemplary embodiment, a vehicle exhaust system includes a conduit defining an exhaust gas flow path extending along a first portion defining a first center axis and a second portion defining a second center axis. The conduit includes a doser opening. An exhaust gas aftertreatment component is connected to a downstream end of the conduit and a mixer is positioned upstream of the exhaust gas aftertreatment component. The mixer includes a plurality of deflecting elements. At least one doser injects DEF into the conduit through the doser opening and upstream of the mixer. A heating element pre-heats the DEF prior to mixing with exhaust gas and a perforated pipe is positioned within the exhaust gas flow path to surround the DEF injected by the doser.

In a further embodiment of any of the above, the perforated pipe includes a plurality of openings spaced apart from each other about the axis, and wherein the plurality of openings extend along a length of the perforated pipe to a downstream end of the perforated pipe, and wherein the mixer is positioned directly adjacent to the downstream end of the perforated pipe.

In a further embodiment of any of the above, the first center axis is non-parallel with the second center axis and wherein the doser defines an injection axis that is non-parallel to the first center axis and is parallel or non-parallel to the second center axis.

In a further embodiment of any of the above, the first center axis is parallel with the second center axis and wherein the doser defines an injection axis that is parallel or non-parallel to the second center axis.

In another exemplary embodiment, a method for injecting DEF into an exhaust component includes: providing a conduit that defines an exhaust gas flow path extending along a center axis, wherein the conduit includes a doser opening for a doser; positioning an exhaust gas aftertreatment component downstream of the conduit; injecting DEF into the conduit through the doser opening; pre-heating the DEF prior to mixing with exhaust gas; and positioning a perforated pipe within the exhaust gas flow path to surround the DEF injected by the doser.

In a further embodiment of the above, the method includes positioning a mixer immediately downstream of the perforated pipe and immediately upstream of the exhaust gas aftertreatment component.

In a further embodiment of any of the above, the method includes forming the perforated pipe to include a plurality of openings that are spaced apart from each other about a pipe axis and are axially spaced apart from each other along a length of the perforated pipe.

These and other features of this application will be best understood from the following specification and drawings, the following of which is a brief description.

### BRIEF DESCRIPTION OF THE DRAWINGS

FIG. 1 schematically illustrates one example of an exhaust system with a doser according to the subject invention.

FIG. 2 is a side view of one example embodiment of a decomposition pipe.

FIG. 3 is a side view of a perforated pipe from FIG. 2.

FIG. 4 is an end view of the embodiment of FIG. 2.

FIG. 5 is a side view of an embodiment showing different injection axes.

FIG. 6 is a perspective view of another embodiment.

FIG. 7 is a schematic side view of another embodiment.

FIG. 8 is schematic side view of another embodiment.

FIG. 9 is another example of a perforated pipe.

### DETAILED DESCRIPTION

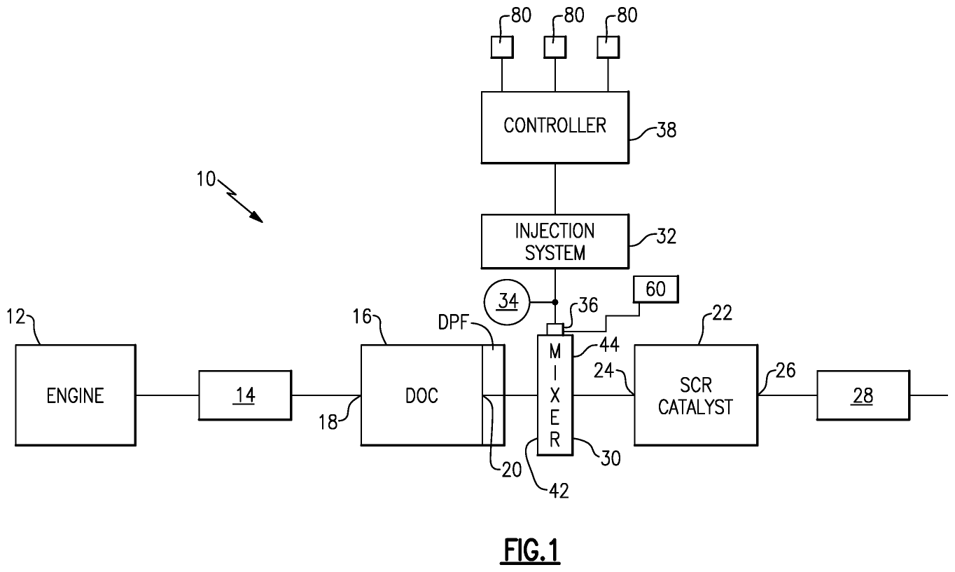

FIG. 1 shows a vehicle exhaust system 10 that conducts hot exhaust gases generated by an engine 12 through various upstream exhaust components 14 to reduce emission and control noise as known. In one example configuration, the upstream exhaust component 14 comprises at least one pipe that directs engine exhaust gases into one or more exhaust gas aftertreatment components. In one example, the exhaust gas aftertreatment components include a diesel oxidation catalyst (DOC) 16 having an inlet 18 and an outlet 20, and an optional diesel particulate filter (DPF) that is used to remove contaminants from the exhaust gas as known. Downstream of the DOC 16 and optional DPF is a selective catalytic reduction (SCR) catalyst 22 having an inlet 24 and an outlet 26. The outlet 26 communicates exhaust gases to downstream exhaust components 28. Optionally, component 22 can comprise a catalyst that is configured to perform a selective catalytic reduction function and a particulate filter function. The various downstream exhaust components 28 can include one or more of the following: pipes, filters, valves, catalysts, mufflers etc. These upstream 14 and downstream 28 components can be mounted in various different configurations and combinations dependent upon vehicle application and available packaging space.

A mixer 30 is positioned downstream from the outlet 20 of the DOC 16 or DPF and upstream of the inlet 24 of the SCR catalyst 22. The upstream catalyst and downstream catalyst can be in-line or in parallel, for example. The mixer 30 is used to facilitate mixing of the exhaust gas.

An injection system 32 is used to inject a reducing agent, such as diesel exhaust fluid (DEF), for example, into the exhaust gas stream upstream from the SCR catalyst 22 such that the mixer 30 can mix the DEF and exhaust gas thoroughly together. The injection system 32 includes a fluid supply 34, a doser 36, and a controller 38 that controls injection of the fluid as known. The doser 36 injects the DEF upstream of the mixer 30. In one example, the mixer 30 comprises an outer band 40 having an upstream end 42, a downstream end 44, and a plurality of deflecting elements 46 (FIG. 2) to direct a mixture of engine exhaust gas and DEF to the SCR catalyst 22.

Providing ultra-low NOx emissions requires dosing at low temperatures to address de-nox at cold start and low load cycles. Dosing DEF at low temperatures raises thermolysis and deposit issues as there is usually insufficient heat from the exhaust gas to manage deposits. To address these issues, the injection system 32 heats the DEF prior to entering the mixer 30, which provides for faster atomization and better mixing, and additionally includes a flow diverting device, such as a perforated pipe 48 for example, that is positioned around the injected DEF spray to minimize spray diversion and further facilitate mixing. Using this configuration for dosing and mixing reduces the overall required packaging space, provides for lower thermal inertia, and has a faster conversion to ammonia, while also providing a more uniform distribution on an upstream face of the SCR catalyst 22.

In one disclosed example shown in FIG. 2, the vehicle exhaust system 10 includes a conduit/decomposition pipe 50 defining an exhaust gas flow path extending along a first portion 52 defining a first center axis A1 and a second portion 54 defining a second center axis A2. The decomposition pipe 50 can comprise a pipe or a tube having any type of cross-section. The decomposition pipe 50 includes a doser opening 56 through which the doser 36 injects the DEF. The exhaust gas aftertreatment component, the SCR catalyst 22 for example, is connected to a downstream end 58 of the decomposition pipe 50. In one example, a perforated plate 62 is positioned immediately upstream of the upstream end face of the catalyst to further improve mixing. The mixer 30 is positioned upstream of the perforated plate 62 and SCR catalyst 22, and the doser 36 is positioned to inject DEF into the decomposition pipe 50 upstream of the mixer 30. A heating element 60 (FIG. 1) is associated with the doser 36 and is used to pre-heat the DEF prior to mixing with exhaust gas. Any type of heating element 60 suitable for heating DEF can be used. Preheating of the DEF occurs in the doser 36 before the DEF is dosed into the exhaust system. The heated DEF can be in the form of a liquid, gas, or a mixture of both. The perforated pipe 48 is positioned within the exhaust gas flow path to surround the DEF (FIG. 5) injected by the doser 36.

The perforated pipe 48 defines a pipe center axis P as shown in FIG. 3 and includes a plurality of openings 70 that extend through a wall thickness of the pipe 48. The openings 70 are are spaced apart from each other about the pipe center axis P. The openings 70 also extend along a length of the perforated pipe 48 to a downstream end 72 of the perforated pipe 48. In one example, there are a greater number of openings in the downstream end 72 than in an upstream end 74 of the perforated pipe 48. In one example, a portion 64 of the upstream end 74 of the pipe 48 extends outwardly of the decomposition pipe 50. This portion does not include any openings 70.

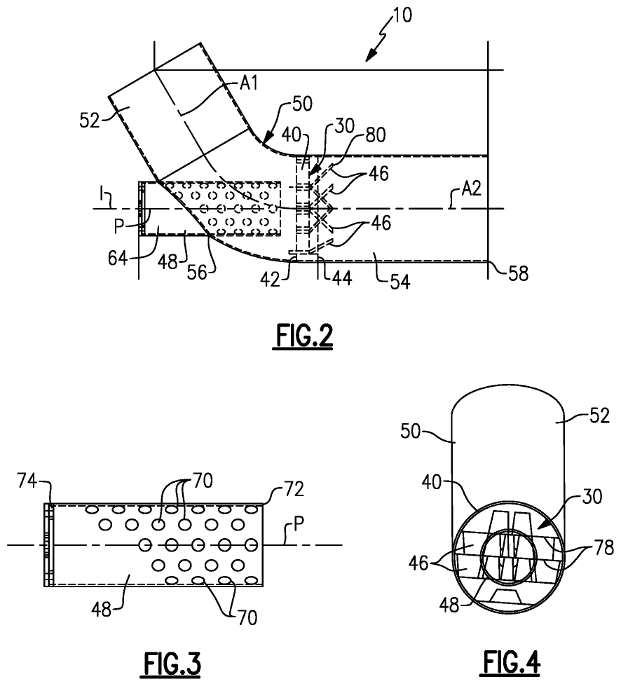

In one example, the mixer 30 is positioned directly adjacent to the downstream end 72 of the perforated pipe 48. In other examples, the mixer 30 may not be required; however, the mixer 30 is preferred because the mixing of the fluid and exhaust gas is more uniform across the section of the decomposition pipe 50. As discussed above, in one example configuration, the mixer 30 comprises an outer band 40 having an upstream end 42, a downstream end 44, and a plurality of deflecting elements 46 as shown in FIGS. 2-3. The outer band 40 is fixed to the decomposition pipe 50 and straight members 78 (FIG. 4) extend across the flow path surrounded by the band 40. The deflecting elements 76 comprise flat tabs having one end fixed to the straight members 78 of the band 40 and which extend to an unsupported distal end 80 at an angle relative to the axis A2. The tabs can be orientated and various different angles relative to each other. The mixer configuration is just one example of a mixer that can be used downstream of the perforated pipe 48, and other types of mixing elements, baffles, and/or mixing plates could also be used.

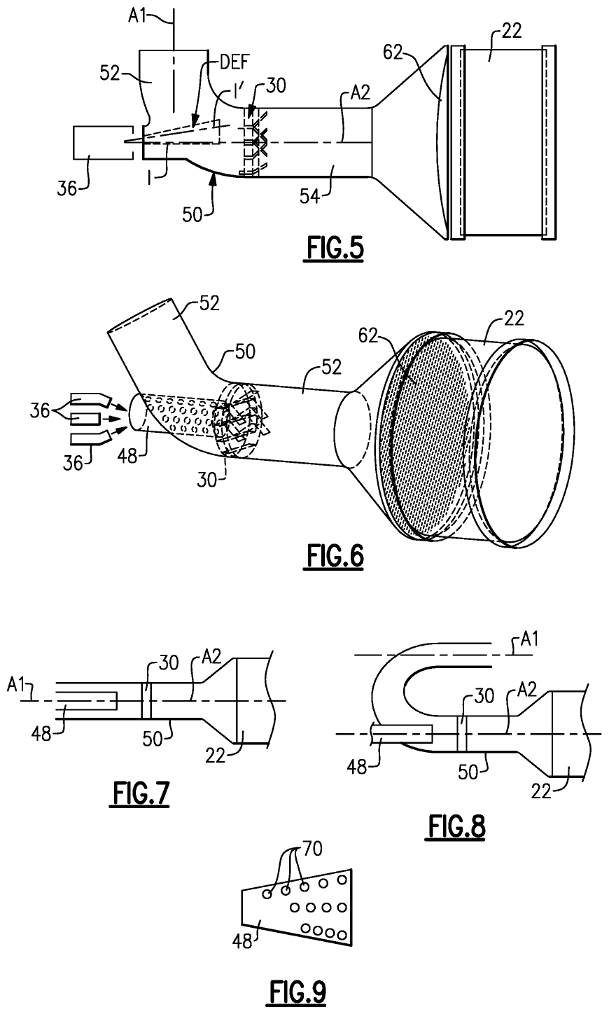

As shown in FIG. 5, the doser 36 defines an injection axis I that is parallel with the second center axis A2, or an injection axis I′ that is non-parallel with the second center axis A2. In the example shown in FIG. 2, the first portion 52 of the decomposition pipe 50 with the first center axis A1 is non-parallel with the second portion 54 of the decomposition pipe 50 with the second center axis A2. In one example, the first portion 52 is orientated at generally 120 degrees relative to the second portion 54; however, other angular configurations could also be used. Further, in this example, the injection axis I is non-parallel to the first center axis A1 and is parallel to the second center axis A2; however the injection axis could also be at an angle relative to the axis, i.e. non-parallel to the axis. Optionally, the angle of the pipe turn could be all the way from a straight pipe (FIG. 7) wherein the first A1 and second A2 axes are concentric to a double back pipe (FIG. 8) wherein the first A1 and second A1 axes are parallel and spaced apart from each other.

In one example, the perforated pipe 48 is defined by an outer diameter that remains constant along a length of the perforated pipe 48 as shown in FIG. 3. In another example, the perforated pipe 48 is defined by an outer diameter that varies along a length of the perforated pipe 48 as shown in FIG. 9. The diameter and/or cross-sectional area can be of any shape, e.g. circle, oval, elliptical, polygonal, conical, etc., and can vary along the length as needed.

FIG. 6 shows an example where there are a plurality of dosers 36. The dosers 36 can be the same or different types. Further, the dosers 36 can be any combination of heated and non-heated dosers.

A control system includes the controller 38 that controls heating of the DEF and/or injection of the DEF based on one or more of exhaust gas temperature, backpressure, time, and wear. Additionally, there are a plurality of sensors 80 that can be used to determine temperature, flow rates, rate of deposit formation, and wear, for example.

In one example, the pipe can be made of a steel or other similar material and/or can have variable material properties. The pipe may also comprise a twin-wall pipe. Additional mixing elements such as baffles and/or perforated plates could also be used as needed. Also, a thermal or hydrolysis barrier could be added to the mixing elements if needed.

As discussed above, the SCR catalyst 22 is used to reduce NOx emissions by using NH3 as the catalytic reductant. The injection system 32 injects NH3 as heated DEF fluid. The catalytic reduction is based on the ammonia decomposition and SCR activation. It is difficult for these two actions to occur at lower temperatures. The first step in ammonia decomposition is to evaporate the water in the DEF fluid, which is a process called thermolysis. During the process of mixing, the DEF fluid takes this energy from the exhaust heat; however, at lower temperatures, as the exhaust gas does not have enough energy, the water does not evaporate completely and this results in an increase in deposit formation.

The subject injection system 32 is able to dose DEF fluid at lower temperatures as the pre-heating of the DEF will help atomize the DEF to smaller diameter particles. This will increase the heat transfer from the exhaust gas to the droplets resulting in faster decomposition. The deflecting device/perforated pipe 48 is added at the spray injection location to make sure the exhaust flow does not deflect the already fine particles of the DEF towards a wall of the decomposition pipe 50. This perforated pipe 48 also creates a finer mixing zone for the DEF with the exhaust. Optionally, an upstream mixing device can be used to further improve the mixing of the DEF with the exhaust gas. Further, the decomposition pipe heated dosing mixer can be used in different architectures where mixing is required in downpipes within a short distance. Examples of these architectures include a light off SCR in close coupled engine compartment position, a light off close coupled DOC in engine compartment position, or a dual dosing dual SCR configuration.

Although an embodiment of this invention has been disclosed, a worker of ordinary skill in this art would recognize that certain modifications would come within the scope of this invention. For that reason, the following claims should be studied to determine the true scope and content of this invention.

1. A vehicle exhaust system comprising:
a conduit defining an exhaust gas flow path extending along a center axis, wherein the conduit includes a doser opening;
an exhaust gas aftertreatment component positioned downstream of the conduit;
at least one doser to inject fluid into the conduit through the doser opening;
a heating element to pre-heat the fluid prior to mixing with exhaust gas; and
a perforated pipe positioned within the exhaust gas flow path to surround the fluid injected by the doser.

2. The vehicle exhaust system according to claim 1, including a mixer positioned upstream of the exhaust gas aftertreatment component and downstream of the perforated pipe.

3. The vehicle exhaust system according to claim 2, wherein the mixer comprises an outer band fixed to an inner surface of the conduit and a plurality of deflecting elements supported by the band.

4. The vehicle exhaust system according to claim 3, wherein the plurality of deflecting elements comprise flat tabs having one end associated with the band and extending to an unsupported distal end at an angle relative to the center axis.

5. The vehicle exhaust system according to claim 2, wherein the perforated pipe includes a plurality of openings spaced apart from each other about the axis.

6. The vehicle exhaust system according to claim 5, wherein an upstream portion of the perforated pipe extends outwardly of the conduit through the doser opening and wherein a downstream portion of the perforated pipe includes the plurality of openings that are axially spaced apart from each other and extend to an outlet end of the perforated pipe.

7. The vehicle exhaust system according to claim 5, wherein the mixer is positioned immediately adjacent to an outlet end of the perforated pipe.

8. The vehicle exhaust system according to claim 2, wherein the doser injects along an injection axis that is parallel to the center axis.

9. The vehicle exhaust system according to claim 2, wherein the doser injects along an injection axis that is non-parallel to the center axis.

10. The vehicle exhaust system according to claim 1, wherein the perforated pipe is defined by an outer diameter that remains constant along a length of the perforated pipe.

11. The vehicle exhaust system according to claim 1, wherein the perforated pipe is defined by an outer diameter that varies along a length of the perforated pipe.

12. The vehicle exhaust system according to claim 1, wherein the at least one doser comprises a plurality of dosers.

13. The vehicle exhaust system according to claim 1, including a control system that controls heating of the fluid and/or injection of the fluid based on one or more of exhaust gas temperature, backpressure, time, and wear.

14. A vehicle exhaust system comprising:
a conduit defining an exhaust gas flow path extending along a first portion defining a first center axis and a second portion defining a second center axis, and wherein the conduit includes a doser opening;
an exhaust gas aftertreatment component connected to a downstream end of the conduit;
a mixer positioned upstream of the exhaust gas aftertreatment component, wherein the mixer includes a plurality of deflecting elements;
at least one doser to inject DEF into the conduit through the doser opening and upstream of the mixer;
a heating element to pre-heat the DEF prior to mixing with exhaust gas; and
a perforated pipe positioned within the exhaust gas flow path to surround the DEF injected by the doser.

15. The vehicle exhaust system according to claim 14 wherein the perforated pipe includes a plurality of openings spaced apart from each other about the axis, and wherein the plurality of openings extend along a length of the perforated pipe to a downstream end of the perforated pipe, and wherein the mixer is positioned directly adjacent to the downstream end of the perforated pipe.

16. The vehicle exhaust system according to claim 14 wherein the first center axis is non-parallel with the second center axis and wherein the doser defines an injection axis that is non-parallel to the first center axis and is parallel or non-parallel to the second center axis.

17. The vehicle exhaust system according to claim 14 wherein the first center axis is parallel with the second center axis and wherein the doser defines an injection axis that is parallel or non-parallel to the second center axis.

18. A method for injecting DEF into an exhaust component comprising the steps of:
providing a conduit that defines an exhaust gas flow path extending along a center axis, wherein the conduit includes a doser opening for a doser;
positioning an exhaust gas aftertreatment component downstream of the conduit;
injecting DEF into the conduit through the doser opening;
pre-heating the DEF prior to mixing with exhaust gas; and
positioning a perforated pipe within the exhaust gas flow path to surround the DEF injected by the doser.

19. The method according to claim 18 including positioning a mixer immediately downstream of the perforated pipe and immediately upstream of the exhaust gas aftertreatment component.

20. The method according to claim 18 including forming the perforated pipe to include a plurality of openings that are spaced apart from each other about a pipe axis and are axially spaced apart from each other along a length of the perforated pipe.
